(19) United States
(12) Patent Application Publication
(10) Pub. No.: US 2021/0358317 A1
(43) Pub. Date: Nov. 18, 2021

(54) SYSTEM AND METHOD TO GENERATE SETS OF SIMILAR ASSESSMENT PAPERS

(71) Applicant: INDIAVIDUAL LEARNING PRIVATE LIMITED, Bangalore (IN)

(72) Inventors: Keyur FALDU, Bangalore (IN); Soma DHAVALA, Bangalore (IN); Achint THOMAS, Bangalore (IN); Aditi AVASTHI, Koramangala (IN)

(73) Assignee: INDIAVIDUAL LEARNING PRIVATE LIMITED, Bangalore (IN)

(21) Appl. No.: 17/318,909

(22) Filed: May 12, 2021

(30) Foreign Application Priority Data
May 13, 2020 (IN) 202041020214

(51) Int. Cl. G09B 3/10; G06N 5/02; G06K 9/62; G06K 9/00; G06F 16/901; G06F 16/906; G06F 16/908

(52) U.S. Cl. CPC G09B 3/10; G06N 5/022; G06K 9/6215; G06F 16/908; G06K 9/6264; G06F 16/9024; G06F 16/906; G06K 9/00483

(57) ABSTRACT

A system for generating a second set of similar assessment papers, from a first set of assessment papers is disclosed. The system includes an identification module, a test paper similarity module and threshold indicator module. The identification module is configured for identifying a plurality of meta-tagged assessment papers based on a numerical representation of each assessment paper of the first set of assessment papers. The test paper similarity module is configured for comparing the numerical representation of each of the identified assessment papers with the numerical representations of each of the other identified assessment papers, for assigning a numerical score to each such possible pair of the identified assessment papers. The threshold indicator module is configured for clustering the identified assessment papers into the second set of similar assessment papers having the numerical score greater than a predetermined threshold, for generating the second set of similar assessment papers.

### PRIORITY STATEMENT

The present application hereby claims priority from Indian patent application number 202041020214 filed on 13 May 2020, the entire contents of which are incorporated herein by reference.

### FIELD

The present disclosure generally relates to data analytics and content packaging and more particularly to a system and a method for identification and generation of a set of similar assessment papers, using question descriptors.

### BACKGROUND

Standardized test based evaluations are conducted to evaluate test takers for skills and competencies. These skills and competencies as referred to herein, can be grouped as academic, behavioral and test-taking skills. Student's score is evaluated based on the assessment papers. Such scores are also taken as reference to improve students' performance. Detailed analysis of student's performance and improvement on such standardized test based evaluations can be found in detail in U.S. Pat. No. 10,854,099 titled: Adaptive learning machine for score improvement and parts thereof granted on Dec. 1, 2020 and publication (Non Patent Literature) Donda, Chintan, et al. “A framework for predicting, interpreting, and improving Learning Outcomes.” arXiv preprint arXiv: 2010.02629 (2020).

Test papers or assessment papers are widely used for conducting several tests (for example, competitive examinations) due to its relative ease of generation and evaluation. The examination process includes use of standardized tests comprising assessment papers with a fixed set of questions to evaluate test takers based on their academic and behavioral abilities and to classify them into various ability levels. Thus, the assessment papers need to incorporate questions with sufficient discrimination factors, syllabus coverage, time-to-solve, and difficulty variations.

Questions in the assessment papers can either be subjective or objective in the style of answers required. Subjective type questions require written sentences, paragraphs, and sometimes drawings or diagrams. The main problem, however, with subjective questions is that the evaluation cannot be uniform due to the subjective nature of answers and evaluator bias, and furthermore, the evaluation process is time consuming and not scalable. Objective type questions alleviate these problems. Since there is only one (or some fixed) possible answer(s) for each question, the evaluation process is uniform. The evaluation process can be automated as well. Standardized testing almost exclusively relies on objective type questions for evaluating the test takers or candidates.

In many situations, due to the large number of candidates appearing for standardized tests, the tests themselves are conducted in batches, over an extended period of time and not all the test takers at the same time. This practice requires the use of multiple versions of the same standardized assessment papers for the various batches. Each test taker of a test batch should, however, face a similar test as the other batches. In other words, there should be no discernable difference in the ability of the test in assessing test takers irrespective of the test batch. Each test batch should measure the same parameters across the same set of dimensions and the goal of the standardized test. Each student or the candidate of the test batch, therefore, should face question that when taken as a whole, represent equivalent discrimination ability. Furthermore, in order to avoid exposing the nature and content of the standardized test, each set of questions present in the assessment paper must be different to ensure fairness of testing across all batches of test takers.

This being the requirements, generating a number of assessment papers similar to each other to conduct a test over multiple batches is manual effort intensive and time-consuming task. The papers so generated are also affected by biases of the paper setter and the generated papers may not be similar to one another to the required degree and hence unfair to the test takers.

### SUMMARY

This summary is provided to introduce a selection of concepts in simple manners that are further described in the detailed description of the disclosure. This summary is not intended to identify key or essential inventive concepts of the subject matter nor is it intended to determine the scope of the disclosure.

To overcome at least some of the above-mentioned problems, wherein the examinations are conducted for evaluating a large number of candidates for a specific assessment, a plurality of similar assessment papers are required for conducting a standardized test. Thus, there is a requirement of multiple versions of the same standardized test comprising a set of similar assessment papers for equal evaluation of the candidates of the various batches. It is preferable to have a set of similar assessment papers for each test batch, so that the candidates are evaluated equally, and each candidate appearing for the standardized test faces tests equivalent to the tests by other candidate's irrespective of the batch.

Briefly, according to an exemplary embodiment, a method for generating a second set of similar assessment papers, from a first set of assessment papers is disclosed. The method includes identifying a plurality of meta-tagged assessment papers of the first set of assessment papers based on a numerical representation of each assessment paper of the first set of assessment papers wherein, the numerical representation of each assessment paper is auto-derived based on a plurality of metadata or descriptors, or both, associated with each question of the first set of assessment papers. The method includes comparing the numerical representation of each of the identified assessment papers with the numerical representations of each of the other identified assessment papers, using one or more of a similarity based metrics for assigning a numerical score to each such possible pair of the identified assessment papers; and clustering the identified assessment papers into the second set of assessment papers based on the numerical scores assigned to each such possible pair of the identified assessment papers.

Briefly, according to an exemplary embodiment, a system for generating a second set of similar assessment papers, from a first set of assessment papers is disclosed. The system includes a processor in communication with a memory, the memory coupled to the processor, wherein the memory comprises a plurality of modules capable of being executed by the processor to perform operations. The plurality of modules includes an identification module, a test paper similarity module and a threshold indicator module. The identification module is configured for identifying a plurality of meta-tagged assessment papers, of the first set of assessment papers based on a numerical representation of each assessment paper of the first set of assessment papers, wherein the numerical representation of each assessment paper is auto-derived based on a plurality of predicted metadata or predicted descriptors, or both, associated with each question of the first set of assessment papers. The test paper similarity module is configured for comparing the numerical representation of each of the identified assessment papers with the numerical representations of each of the other identified assessment papers, using one or more of a similarity based metrics for assigning a numerical score to each such possible pair of the identified assessment papers. The threshold indicator module is configured for clustering the identified assessment papers into the second set of similar assessment papers based on pairs having numerical scores greater than a predetermined threshold, for generating the second set of similar assessment papers.

The summary above is illustrative only and is not intended to be in any way limiting. Further aspects, exemplary embodiments, and features will become apparent by reference to the drawings and the following detailed description.

### BRIEF DESCRIPTION OF THE FIGURES

These and other features, aspects, and advantages of the exemplary embodiments can be better understood when the following detailed description is read with reference to the accompanying drawings in which like characters represent like parts throughout the drawings, wherein:

FIG. 1 is a block diagram of a system configured for generating a second set of similar assessment papers, from a first set of assessment papers, using computed metadata or descriptors, or both, associated with each question of the first set of assessment papers, implemented according to an embodiment of the present disclosure;

FIG. 2 is a detailed diagram of a system, wherein the system is configured for generating a second set of similar assessment papers from a given first set of assessment papers, implemented according to an embodiment of the present disclosure;

FIG. 3 is a flow chart illustrating method steps for the identification of M similar test papers for a given collection of N test papers using the graph based technique;

FIG. 4 is a flow chart illustrating method steps for generating a second set of similar assessment papers from a given first set of assessment papers;

FIG. 5 is an example illustration showing results of the comparison obtained by the test paper similarity module, implemented according to an embodiment of the present disclosure; and

FIG. 6 is a block diagram of an electronic device, implemented according to an embodiment of the present disclosure.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having the benefit of the description herein.

### DETAILED DESCRIPTION

For the purpose of promoting an understanding of the principles of the invention, reference will now be made to the embodiments illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not comprise only those steps but may comprise other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

In addition to the illustrative aspects, exemplary embodiments, and features described above, further aspects, exemplary embodiments of the present disclosure will become apparent by reference to the drawings and the following detailed description.

Embodiments of the present disclosure particularly disclose a system and a method configured for generating a second set of similar assessment papers, from a first set of assessment. The system as disclosed herein is configured for identifying a plurality of meta-tagged assessment papers, for generating a second set of similar assessment papers, from a first set of assessment papers. The system uses metadata tagged to each question in an assessment paper. The questions in each assessment paper are selected from a database of questions. The database has metadata associated with each question. The metadata of each question may include data such as chapter, difficulty level of the question, average time to answer the question, node of the knowledge graph (also called knowledge base) associated with the question, and the like. Using the metadata associated with each question, a numerical representation of the assessment paper is derived. In one embodiment, this numerical representation can take the form of a vector. Vectors of each assessment paper are then compared with all the other assessment papers in the first set using similarity metrics. In one example embodiment, cosine similarity may be used as a metric. The similarity metric assigns a numerical score to each pair of assessment papers. The assessment papers having a numerical score within a predetermined range of scores are treated to be similar to one another, for this purpose. Metadata for each question is computed using Artificial Intelligence (AI) models trained using either expert labelled data or calibrated data from historical student attempts. It is to be noted that, for the system to identify the plurality of meta-tagged similar assessment papers from a given set of assessment papers, a pre-requisite is to first find paper-to-paper similarity scores and then use each score computed between every possible pairs of assessment papers in a graph algorithm to form the set of similar papers.

Embodiments of the present disclosure particularly disclose a system and a method configured for predicting a plurality of descriptors (metadata) for a given set of questions in the assessment paper, using AI techniques, computing a similarity score between two assessment papers using the predicted descriptors for the questions. The computation of similarity score is done for all possible pairs of the assessment papers in the set. Further, embodiments of the present disclosure particularly disclose a system and a method configured for identifying a second set of similar assessment papers, from a given first set of assessment papers using the computed score. Furthermore, the embodiments of the present disclosure also include a method of improving the similarity score of an assessment paper having low score, such that it is possible to select a desired number of similar test papers.

In some embodiments, the word ‘test paper’, ‘assessment paper’, ‘question paper’ and ‘paper’ used in the description may reflect the same meaning and may be used interchangeably. In some embodiments, the word ‘user’, ‘candidate’, and ‘student’ used in the description may reflect the same meaning and may be used interchangeably. Embodiments of the present invention will be described below in detail with reference to the accompanying figures.

To further clarify advantages and features of the present invention, a more particular description of the invention will be rendered by reference to specific embodiments thereof, which is illustrated in the appended figures. It is to be appreciated that these figures depict only typical embodiments of the invention and are therefore not to be considered limiting of its scope. The invention will be described and explained with additional specificity and detail with the accompanying figures.

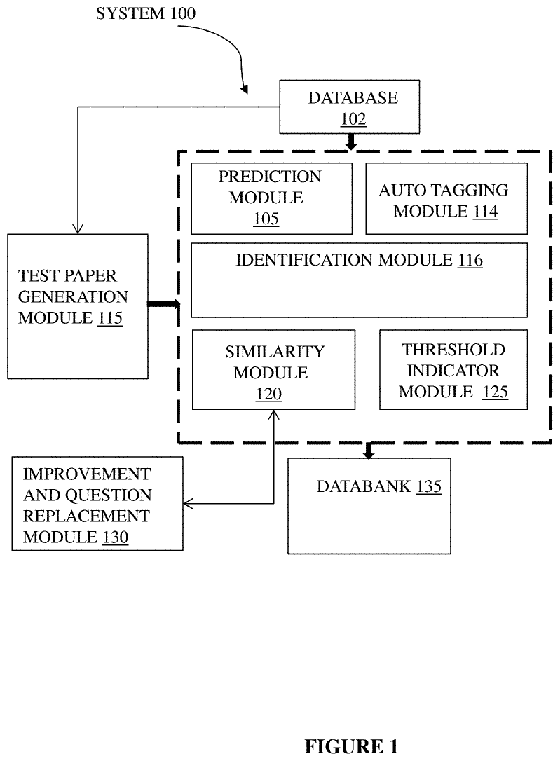

FIG. 1 is a block diagram of a system 100 configured for generating a second set of similar assessment papers, from a first set of assessment papers, using computed metadata or descriptors, or both, associated with each question of the first set of assessment papers, implemented according to an embodiment of the present disclosure. In particular, the system 100 illustrates a database 102 storing a plurality of question datasets, a question descriptor prediction module 105, a question descriptor auto tagging module 114, a test paper generation module 115, an identification module 116 comprising a plurality of meta-tagged assessment papers also referred to as meta-tagged candidate test paper set, a test paper similarity module 120, a threshold indicator module 125, a test paper improvement and question replacement module 130, and a databank 135. Each block is explained in detail further below.

The system 100 is implemented for use when examinations are conducted in batches for evaluating several candidates for a specific assessment over a period of time. The system 100 is configured for generating assessment papers for the same standardized test comprising a set of similar assessment papers for equal or equivalent evaluation of the candidates of the various batches (for example, the number of batches may be eight to ten). The system 100 is configured for identifying the plurality of meta-tagged assessment papers and generating the second set of similar assessment papers, from the plurality of meta-tagged assessment papers for the test batches, so that the candidates are evaluated substantially equally, and each candidate appearing for the standardized test faces a test equivalent to all the others.

The manner in which an assessment paper of a given quality level is generated using the test paper generation module 115 is described in detail in Indian patent application numbered 201941012257 and U.S. Patent Application numbered Ser. No. 16/684,434 titled “System and method for generating an assessment paper and measuring the quality thereof” having priority date of: Mar. 28, 2019, the complete content of which is incorporated herein by reference. Using such a system as disclosed in the referred patent application, it is possible to generate many assessment papers relatively easily. However, the problem of ensuring that the various test papers generated are similar enough to each other to be considered as being equivalent for a pool of test takers must be addressed.

It is to be noted that the ‘first set of assessment papers’ as referred to in the claims and description of the present disclosure are the assessment papers generated using the test paper generation module 115 of the system 100. The first set of assessment papers are generated by implementing one of automatic test generation methods and manual methods, or both.

The system 100 includes the database 102 storing a plurality of questions. The questions in the database 102 are each linked to a node of a knowledge base. The knowledge base comprises content arranged as a topology comprising a plurality of interlinked nodes, wherein, each node represents a concept. The knowledge base is described in detail in Indian patent application numbered 201941012401 and US patent application numbered Ser. No. 16/586,512 titled “System and method for recommending personalized content using contextualized knowledge base”, having priority date of: Mar. 29, 2019, the complete content of which is incorporated herein by reference. The manner in which the knowledge base is leveraged in academic context for academic content is described in detail in Indian patent application: 201941012256 and U.S. patent application Ser. No. 16/740,223 titled “System and method for personalized retrieval of academic content in a hierarchical manner”, having priority date of: Mar. 28, 2019, the complete content of which is incorporated herein by reference.

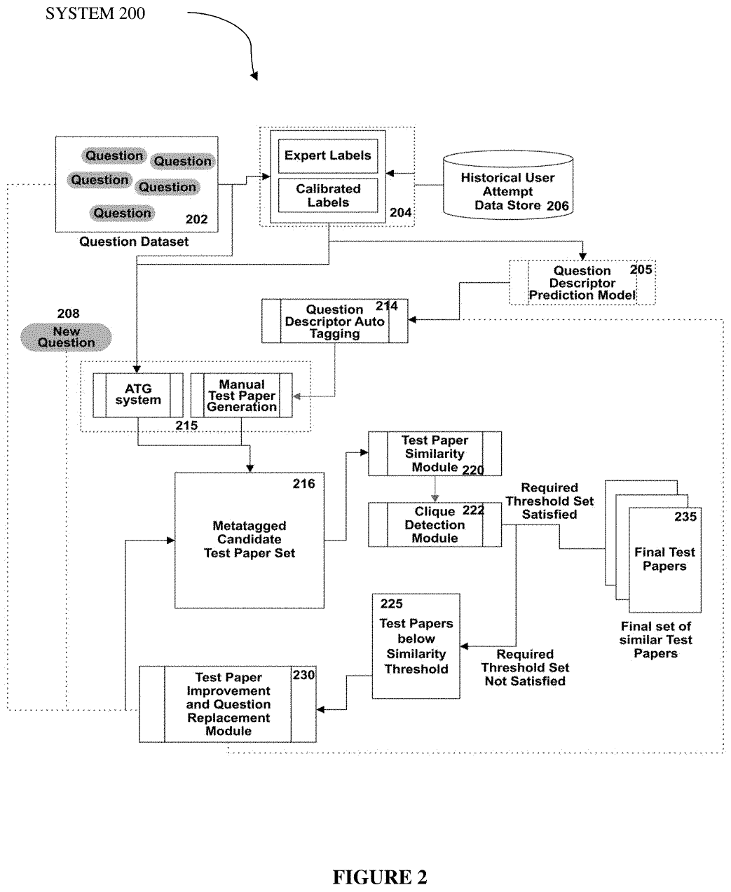

Furthermore, for each question stored in the database 102, a metadata or a subset of it is also stored which is tagged to each question. Each question in the assessment paper set needs meta-tags (metadata) of descriptors such as for example, contextualized Knowledge Graph, difficulty level, and ideal time. The question descriptor auto tagging module 114 implements AI models to auto-derive these meta-tags of descriptors. Further, these AI models require labelled data, or historical data to train on. Such data is termed training data. This training data is derived using the methods as described in detail with reference to FIG. 2 further below in the present disclosure.

The system 100 includes a prediction module 105 implementing a prediction model configured (which is an AI model) for predicting a plurality of ‘test paper descriptors’ (for example, question descriptors or metadata) for a given set of questions. The question descriptor prediction module 105 is configured for predicting a plurality of metadata or descriptors, or both, for each question stored in database 102, by implementing one or more AI models trained using at least one of expert labelled data or calibrated labelled data. The manner in which the AI models are trained, is described in detail in FIG. 2 further below in the present disclosure.

In one embodiment, the expert labelled data for each question is derived with the assistance of a plurality of experts in an area of knowledge related to each question and is determined using techniques such as majority voting and bias discounting. In another embodiment, the calibrated labelled data is derived using historical user attempt data extracted from a data store. The calibrated labelled data is derived using statistical modeling from historical user attempt data extracted from the data store and leveraging their mapping to a node of the knowledge graph.

In one example, the plurality of metadata or descriptors, or both, of each question comprise data selected from a list of data comprising, but not limited to, data obtained from contextualized knowledge graph mapping, ideal time, discrimination slope, guessability, behavioral attributes, bloom level tagging, question sequencing, chapter, difficulty level of the question, average time to answer the question, and node of a knowledge graph associated with the question. For example, the behavioral attributes comprise, but not limited to, data obtained based on careless mistakes, overtime incorrects, too fast corrects, time spent not attempting on a question.

In one embodiment, each question of the first set of assessment papers includes questions obtained from the database 102, wherein each question is linked to a node of a knowledge base and may also include a newly added question. For instance, if a question is completely new and a question is not seen by public, such a question will not have any historical user attempt data but may have all other metadata attributes. In one example, this newly added question may not have any historical user attempts data, but it may have other metadata such as knowledge graph node mapping, ideal time, difficulty level and the like. Such metadata will be the result of predictions or computations from AI models which are trained using expert labelled data and/or calibrated labels data.

As mentioned above, the test paper generation module 115 includes the first set of assessment papers.

For identifying the plurality of meta-tagged assessment papers of the first set of assessment papers, the identification module 116 of the system 100 uses metadata tagged for each question in the assessment paper. The questions in each assessment paper are selected from the database 102 of questions. The database 102 has metadata associated with each question. The metadata of each question may include data such as chapter, difficulty level of the question, average time to answer the question, node of the knowledge graph associated with the question, and the like. Using the metadata associated with each question, a numerical representation of the assessment paper is derived.

Thus, the identification module 116 is configured for identifying the plurality of meta-tagged assessment papers of the first set of assessment papers based on a numerical representation of each assessment paper of the first set of assessment papers. The numerical representation of each assessment paper is auto-derived based on a plurality of computed metadata or computed descriptors, or both, associated with each question of the first set of assessment papers. The meta-tagged assessment papers are also referred to as meta-tagged candidate test paper set.

In one embodiment, this numerical representation which is derived can take the form of a vector. All assessment paper vectors are then compared to one another using similarity metrics. The similarity metric assigns a numerical score to each pair of assessment papers. The assessment papers having a numerical score within a predetermined range of scores are treated to be similar to one another, for this purpose.

Thus, the test paper similarity module 120 is configured for computing the similarity scores between two assessment papers using the meta data for each question or descriptors predicted using AI techniques. The computation of similarity score is done for all possible pairs of the assessment papers in the meta-tagged candidate test paper set.

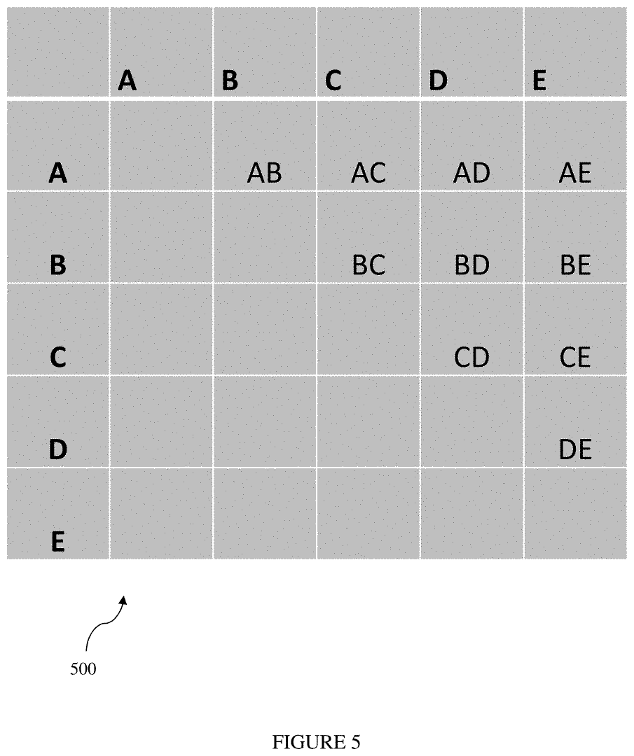

The test paper similarity module 120 is configured for comparing the numerical representation of each of the identified assessment papers (meta-tagged assessment papers meta-tagged assessment papers) with the numerical representations of each of the other identified assessment papers, using one or more of a similarity based metrics for assigning a numerical score to each such possible pair of the identified assessment papers. The results of the comparison are shown exemplarily in FIG. 5 in the form of a table 500. In the table AB, AC, . . . DE shows the results of the comparison. Therein, A, B, C, D, E are the identification of papers. The first alphabet is the identification of the paper and the second alphabet is the paper it is being compared with. This table is shown as means of understanding the steps and not that the results are stored in a table or a matrix.

It is to be noted that, for generating the second set of similar assessment papers from the given first set of assessment papers, a pre-requisite is to first find paper-to-paper similarity score and then use each score computed between pairs of papers in a graph algorithm to form the set of similar papers.

The test paper similarity module 120 is also configured for improving the similarity score of assessment papers with low scores, such that it is possible to select the desired number of similar test papers. The test paper similarity module 120 is coupled to the test paper improvement and question replacement module 130 for replacement of questions in sorted order from the given collection of questions to increase the overall computed score of the given assessment paper, by adhering to constraints of question metadata requirements for maintaining the required quality.

The identified assessment papers are clustered into the second set of assessment papers based on the numerical scores assigned to each such possible pair of the identified assessment papers. The threshold indicator module 125 is used for clustering the identified plurality of meta-tagged assessment papers into the second set of similar assessment papers having the scores greater than a predetermined threshold, for generating the second set of similar assessment papers.

In one embodiment, the first step of clustering includes computing a similarity score for quantifying a similarity between any two assessment papers using a numerical score assigned by one or more of the similarity based metrics method to each such possible pair of assessment papers. The second step includes using each similarity score computed between any two assessment papers in a graph algorithm to cluster the identified assessment papers for generating the second set of assessment papers or set of similar papers. It is to be noted that, for the system to generate the second set of similar assessment paper from a given first set of assessment papers, a pre-requisite is to first find paper-to-paper similarity score and then use each score computed between pairs of papers in a graph algorithm to surface the set of similar papers.

The databank 135 is configured for storing the generated second set of similar assessment papers, from a first set of assessment papers. To explain this, let us consider an example scenario, where there are twenty assessment papers in “meta-tagged candidate test papers” set, and finally four assessment papers are generated which are most “similar”. So the final subset which is stored in databank 135 which is the second set of similar assessment papers would include four assessment papers, which is a subset of all the twenty assessment papers.

The second set of assessment papers which are generated by the modules of the system 100 and stored as the final test papers in the databank 135 are utilized for conducting standardized examinations that are conducted for evaluating numerous candidates for a specific assessment.

The manner in which the modules of the system 100 of FIG. 1 operate in some embodiments, for identifying and generating the second set of similar assessment papers from a given first set of assessment papers, using predicted descriptors is described in further detail below.

FIG. 2 is a detailed diagram of a system 200, wherein the system 200 is configured for generating a second set of similar assessment papers from a given first set of assessment papers, implemented according to an embodiment of the present disclosure. The second set of similar assessment papers are generated from the given first set of assessment papers, using metadata or descriptors, or both, tagged to each question stored in the database 202. In one embodiment, the descriptors and metadata tagged to each question in the database 202 are computed manually. In another embodiment, the descriptors and metadata tagged to each question in the database 202 are obtained by implementing one or more AI models.

The system 200 includes the database 202, a label generation module 204, a question descriptor prediction module 205, a data store 206, a new question input module 208, a question descriptor auto tagging module 214, a test paper generation module 215, a meta-tagged candidate test paper set 216, a test paper similarity module 220, a clique detection module 222, a threshold indicator module 225, a test paper improvement and question replacement module 230, and a databank 235. In particular, the database 202 is configured for storing a plurality of question datasets. It is to be noted that the question's or question datasets as shown in FIG. 2 are one and the same.

The label generation module 204 includes labels derived from an expert's label 204-A and calibrated labels 204-B. The data store 206 is configured for storing historical data associated with user attempts for a question. The test paper generation module 215 is coupled to an Automatic Test Generation (ATG) system 215-A and a manual test paper generation module 215-B. The test paper generation module 215 is configured for generating a plurality question papers/assessment papers. It is to be noted that the ‘first set of assessment papers’ as referred to in the claims of the application are the assessment papers generated using the test paper generation module 215 of the system 200. The databank 235 is configured for storing a final set of similar test papers (also referred as second set of similar assessment papers). Each block is explained in detail further below.

Embodiments of the present disclosure particularly disclose the system 200 configured for generating the second set of assessment papers which is a subset of and from the given first set of assessment papers, using descriptors or metadata, or both. The second set of assessment papers which are generated by the modules of the system 200 and stored as the final test papers in the databank 235 are utilized for conducting standardized examinations that are conducted for evaluating numerous candidates for a specific assessment. Thus, the system 200 accomplishes the requirement of the same standardized test comprising the second set of similar assessment papers generated from the given first set of assessment papers for evaluating the candidates, in different batches.

Referring again to FIG. 2, the system 200 includes the database 202 storing a plurality of questions. The questions in the database 202 are each linked to a node of a knowledge base as explained above in FIG. 1.

As described above, the test questions are stored in the database 202. Furthermore, for each question stored in the database 202, a metadata or a subset of it is also stored which is tagged to each question.

In one example, the metadata for a question may be a question text or an image body associated with the question. In one example, the metadata for a question may be a question tagged to academic learning maps. In one example, the metadata for a question may be question tagged to one or more concepts on Contextual Knowledge Base (Graph). In one example, the metadata for a question may be textual attributes present in the questions, such as for example, vocabulary vectors, syntactic and semantic vectors. In one example, the metadata for a question may be question image attributes such as object vectors. In one example, the metadata for a question may be the step by step solutions. In one example, the metadata for a question may be historical user attempt data for that question. For instance, the historical user attempt data may include question attempt status of a user or a candidate, time taken by a user or a candidate to solve a question, correctness of answer attempted by a user or a candidate and so on for all the users who have attempted the question earlier.

It is to be noted that the metadata for a question as described herein, is only sample metadata of possible metadata. Persons skilled in the art can envision other types of metadata that can be stored along with the questions in the database 202. Further, not all metadata may be available for all questions. For instance, if a question is completely new and a question is not seen by public and generated by the new question input module 208, such a question will not have any historical user attempt data but may have all other metadata attributes.

The system 200 further includes the question description prediction module 205 (implementing prediction model which is an AI model) configured for predicting question descriptors or metadata for each question using Artificial Intelligence (AI) models for metadata that may not be available when question papers are created. It becomes imperative to define a set of numerical parameters that can be used as question descriptors for the assessment paper. These numerical parameters are a function of the set of questions that make up the assessment paper. Two or more assessment papers may be similar to one another based on how similar the descriptors are.

In one embodiment, the descriptors are predicted using the question descriptor prediction module 205 for a given set of questions. For example, the descriptors that are predicted, may include descriptors such as contextualized Knowledge Graph mapping, Difficulty level, ideal time, discrimination slope, “guessability”, behavioral attributes (such as careless mistakes, overtime “incorrects”, too fast corrects, time spent not attempting), bloom level tagging, (knowledge, understanding, application), question sequencing and other attributes. The description and explanation of the metadata or descriptors such as guessability, behavioral attributes (such as careless mistakes, overtime “incorrects”, too fast corrects, time spent not attempting), bloom level tagging, (knowledge, understanding, application), question sequencing and other attributes is described in detail in U.S. patent application Ser. No. 16/586,525 titled “System and method for behavioral analysis and recommendations” and filed on Sep. 27, 2019, the complete content of which is incorporated herein by reference.

In one example, the term “overtime incorrects” and “too fast corrects” are explained with an example scenario.

For example, to answer a specific question, a student may need a specified amount of time. This specified amount of time may be termed as ideal time to answer the specific question. Then, an attempt, by the student on the specific question may be considered as “overtime incorrect” if the time taken to answer that question is more than the ideal time for the question and also the answer is incorrect.

Further, an attempt on the specific question is considered “too fast correct” if the time taken to answer the question, by the student is less than approximately a smaller percentage (for example, this is configurable—say 5% or 10%) of the ideal time for the question AND the answer is correct.

The question descriptor prediction module 205 is described in further detail now. Each question in the assessment paper set needs meta-tags (metadata) of descriptors such as contextualized Knowledge Graph, difficulty level, and ideal time. The question descriptor auto tagging module 214 implements AI models to auto-derive these meta-tags of descriptors. Further, these AI models require labelled data, or historical data to train on. Such data is termed as training data. This training data is derived using the following methods described herein. The training data such as experts' labels 204-A and calibrated labels 204-B are estimated using various methods such as labelled data generation 204, and predictive modelling.

The first method for deriving the data for training the AI model, may be based on a labelled data generation. This method includes derivation of labels such as expert labels 204-A and calibrated labels 204-B.

In one embodiment, the expert labelled data 204-A for each question is derived with the assistance of a plurality of experts in a specific area of knowledge related to each question and is determined using techniques such as majority voting and bias discounting. Experts use their expertise and knowledge to add metadata to each question. Labels are assigned by several experts. Further, the system 200 finalizes the labels using majority voting and bias discounting, for example, for selecting the final label for the question. For instance, an expert would know by studying a given question what level of difficulty (on a scale of 1 to 10, for example) the question would occupy. This value would be labeled as the difficulty level of the question. In another instance, by studying a question, an expert would know approximately how long it would take an average student to solve the question. This value would be labeled as the ideal time of the question.

In another embodiment, the derivation of calibrated labels 204-B is done using the historical user attempt data which is extracted from the datastore 206. The historical user attempt data is used for calibration of numerical labels, using statistical methods. In one embodiment, the difficulty level of a question can be calibrated using the accuracy over user attempts from independent and identically distributed students over historical attempts on the question.

In the same embodiment, the leading and trailing outliers in terms of historical user attempts on the question can be discarded before computing the accuracy. In one embodiment, the item response theory models can be used to derive difficulty-level of the question. In the same embodiment, collaborative filtering is used to derive question difficulty. Further, ideal time can be calibrated using time spent by students attempting questions. In the same embodiment, the median time taken by top performing students (top X percentile of students based on ability wherein X is predefined number) when the question is answered correctly. In the same embodiment, the average time taken by all students attempting the questions and getting it correct can be used.

The question descriptor prediction module 205 is based on predictive modelling and utilizes contextualized knowledge graph (knowledge base) tagging, difficulty level prediction and ideal time prediction which are described in subsequent paragraphs.

In one embodiment, the following multi-step approach is used for contextualized knowledge graph auto-tagging. In one example, using labelled questions tagged to knowledge graph and a supervised learning algorithm, new questions can be assigned tags from the knowledge graph. In one example, Deep Neural Network (DNN) based language model fine-tuned on academic data corpus (Wikipedia, books, questions, for example) may be used for contextualized knowledge graph auto-tagging. In one example, DNN based image model fine-tuned on academic corpus may be used for contextualized knowledge graph auto-tagging. In one example, classifiers invoking language model embedding's trained with labelled question data available for training may be used for contextualized knowledge graph auto-tagging.

In one embodiment, the random forest regression models trained on syntactic and semantic textual and image features are used to predict difficulty level.

In one embodiment, random forest regression models trained on syntactic and semantic textual and image features is used to predict ideal time.

In one embodiment, Item Response Theory models trained on historical user attempt data are implemented to predict the discrimination slope of each question (item). In one embodiment, Item Response Theory models trained on historical user attempt data are implemented to predict the “guessability” of each question (item). In one embodiment, behavioral attributes (such as careless mistakes, overtime incorrects, too fast corrects, time spent not attempting) may be implemented for predictive modelling.

The question descriptors which are predicted by implementing the above described methods and by using the question descriptor prediction module 205 are stored and utilized for the determination of similar assessment papers (final assessment papers). With the individual question descriptors available after prediction, similarity measures can be used for computing two or more similar test papers. Since each assessment paper is a collection of a set of questions, each assessment paper is assigned a plurality of descriptors. The test paper descriptor assigned to the question, becomes a vector. The test paper similarity module 220 is configured for utilizing one or more of a similarity based metrics for the determination of similar assessment papers (final assessment papers), using the descriptors assigned.

In one embodiment, similarity measures known in the art such as cosine similarity, Euclidean distance, and Manhattan distance are implemented to compute the similarity coefficient between two sets of questions. This in turn, gives the similarity between two test papers from which these sets of questions are selected. In another embodiment, different weights are assigned to the various constituent descriptors. These weights are learned using statistical techniques from historical user attempt data on sets of questions that have occurred in past test papers.

In one example embodiment, to identify M similar test papers for given a collection or set of N test papers the following graph based technique is used. The set of N test papers may be generated via various methods. The steps for the identification of M similar test papers for a given collection of N test papers using the graph based technique are described below.

In one example, the test paper generation module 215 may include methods for generation of assessment papers. These methods may include manual test paper generation methods or methods using Automatic Test Generation (ATG) module described in detail in Indian patent application numbered 201941012257 and U.S. Patent Application numbered Ser. No. 16/684,434 titled “System and method for generating an assessment paper and measuring the quality thereof” having priority date: Mar. 28, 2019. These manual test paper generation methods or methods using Automatic Test Generation (ATG) module can be found in detail in publication (Non Patent Literature) Dhavala, Soma, et al. “Auto Generation of Diagnostic Assessments and Their Quality Evaluation.” International Educational Data Mining Society (2020).

It is to be noted that the ‘first set of assessment papers’ as referred in the claims of the application are the assessment papers generated using the test paper generation module 215 of the system 200.

An identification module is configured to identify a meta-tagged candidate test paper set 216 from the assessment papers which are generated using the test paper generation module 215. The meta-tagged candidate test paper set 216 is a subset of assessment papers identified of the first set of assessment papers based on a numerical representation of each assessment paper of the first set of assessment papers.

In one embodiment, using the metadata associated with each question, a numerical representation of the assessment paper is auto-derived. The numerical representation of each assessment paper is auto-derived based on a plurality of computed metadata or computed descriptors, or both, associated with each question of the first set of assessment papers.

This numerical representation can take the form of a vector. All assessment paper vectors are then compared to one another using similarity metrics implemented by the test paper similarity module 220. In one example embodiment, cosine similarity may be used as a metric. The similarity metric assigns a numerical score to each pair of assessment papers. The assessment papers having a numerical score within a predetermined range of scores are treated to be similar to one another, for this purpose. In other words, the test paper similarity module 220 is configured for comparing the numerical representation of each of the identified assessment papers (plurality of meta-tagged assessment papers) with the numerical representations of each of the other identified assessment papers, using one or more similarity based metrics for assigning a numerical score to each such possible pair of the identified assessment papers. The threshold indicator module 225 is configured for clustering the identified assessment papers into the second set of assessment papers (final test papers 235) based on the numerical scores assigned to each such possible pair of the identified assessment papers.

Further, the system 200 also includes a test paper improvement and question replacement module 230, wherein the assessment paper of a lower similarity score is taken as input, and its questions contributing to the lower scores are replaced based on the desired metadata descriptors to improve the similarity score of the assessment paper with respect to the final set of similar test papers 235. In other words, the system 200 is configured for improving the similarity score of assessment paper having low score such that it is possible to select a desired number of similar test papers.

In one embodiment, the test paper improvement module 230 is configured for improving the similarity score of the assessment paper having low similarity score with other assessment papers, for identifying a preferred number of assessment papers. Similarity score of the test paper is computed as the average of its similarity score with all other papers. A paper with score lower than pre-determined threshold is selected, and its questions are replaced by question replacement module to improve its similarity score using the module 230. The replacement of questions may improve the similarity score, and also it may increase the number of nodes (test papers) in the clique (222). The clique of graph is a subset of assessment papers, where each paper has high similarity with every other paper in the clique.

This process is done iteratively till we get the desired numbers of similar assessment papers (235). In short, the assessment papers with the lesser similarity score with identified second set of similar assessment papers are selected, and its score is improved by replacing few existing questions with a new questions (208) using module 230.

Further, the system also 200 also includes clique detection module 222 for identifying clique of assessment papers using graph representation, where similarity score between two test papers is used as the relationship. To explain, the clique detection module 222, let's consider an example scenario, where there are four papers, A, B, C, D. Paper A would have lower similarity score if all the mean of similarity score of paper A with all others (i.e. B, C, and D) would be low than other papers. In a clique, each paper would have very high similarity with every other paper. The term clique as used herein carries the meaning as well known in graph theory.

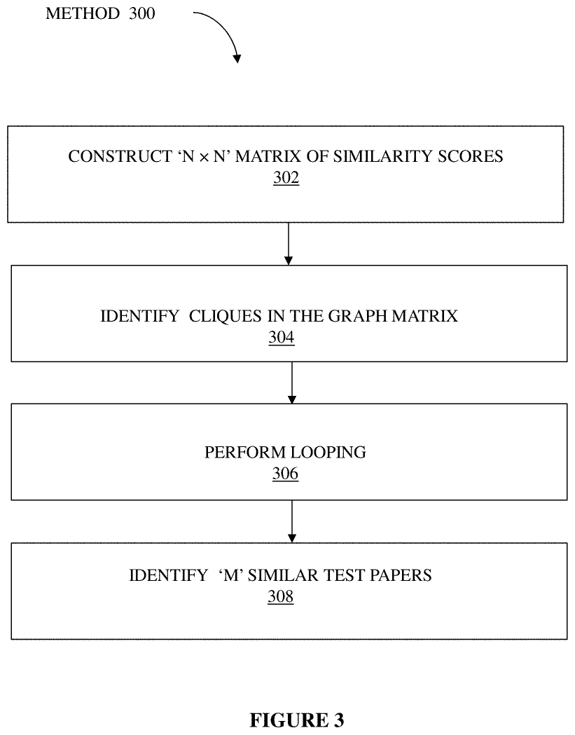

FIG. 3 is a flow chart 300 shows the steps of the method for the identifying M similar test papers for a given collection of N test papers using the graph-based technique. FIG. 3 may be described from the perspective of a processor that is configured for executing computer readable instructions stored in a memory to carry out the functions of the modules (described above in FIG. 2) of the system 200. In particular, the steps as described in FIG. 3 may be executed for identification of M similar test papers for a given collection of N test papers using the graph-based technique. Each step is described in detail below.

At step 302, an N×N matrix of similarity scores is constructed for each pair of test papers. At step 304, the cliques in the graph matrix are identified using threshold on similarity score to include the edge in the graph. At step 306, the sub-steps of looping is performed while clique size identified is less than M. The sub-steps of looping include identification of candidate test papers using, a predetermined threshold tolerance on similarity score, ranking of test paper questions in order of decreasing order of contributing to dissimilarity based on descriptors and replacement of questions in sorted order from the given collection of questions to increase overall similarity score of the given test paper to all other nodes (papers) in the clique, by adhering to constraints of question metadata requirement for maintaining high quality. At step 308, M similar test papers for a given collection of N test papers are identified.

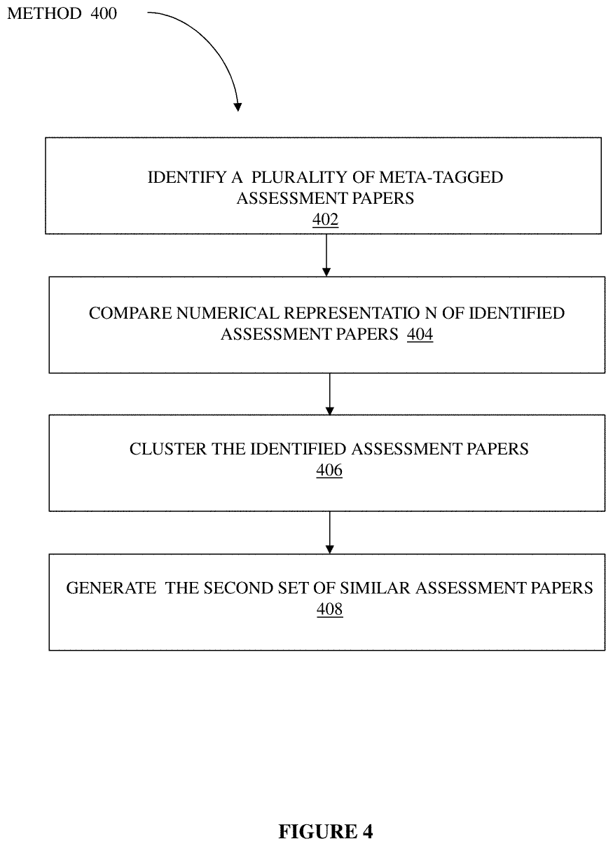

FIG. 4 is a flow chart illustrating the method 400 for generating a second set of similar assessment papers from a given first set of assessment papers. The second set of similar assessment papers are generated from a given first set of assessment papers, using metadata or descriptors, or both, tagged to each question stored in the database. FIG. 4 may be described from the perspective of a processor that executes computer readable instructions stored in a memory, to which the processor is communicatively coupled, to carry out the functions of the modules (described above in FIG. 1) of the system 100. In particular, the steps as described in FIG. 4 may be executed for generating the second set of similar assessment papers. These generated similar assessment papers are utilized for conducting tests which are conducted in batches, so that the candidates are evaluated equally, and all candidates appearing for the standardized test, face equivalent tests. Each step is described in detail below.

At step 402, a plurality of meta-tagged assessment papers the first set of assessment papers are identified based on a numerical representation of each assessment paper of the first set of assessment papers. The numerical representation of each assessment paper is auto-derived based on a plurality of metadata or descriptors, or both, associated with each question of the first set of assessment papers. In one embodiment, the plurality of metadata or descriptors, or both, for each question of the first set of assessment papers are computed or predicted by implementing one or more AI models trained using one of expert labelled data and calibrated labelled data.

The plurality of metadata or descriptors, or both, of each question comprise data selected from a list of data comprising, but not limited to, data obtained from contextualized knowledge graph mapping, ideal time, discrimination slope, guessability, behavioral attributes, bloom level tagging, question sequencing, chapter, difficulty level of the question, average time to answer the question, and node of a knowledge graph associated with the question. In one example, the behavioral attributes comprise, but not limited to, data obtained based on careless mistakes, overtime incorrects, too fast corrects, and time spent not attempting on a question.

It is to be noted, that each question of the first set of assessment papers includes questions obtained from a database, wherein each question is linked to a node of a knowledge base and may also include a newly added question. The first set of assessment papers are generated by implementing one of automatic test generation methods and manual methods.

The expert labelled data for each question is derived with the assistance of a plurality of experts in an area of knowledge related to each question and is determined using techniques such as majority voting and bias discounting. The calibrated labelled data is derived using historical user attempt data extracted from the data store. The calibrated labelled data is derived using statistical modeling from historical user attempt data extracted from the data store and leveraging their mapping to a node of the knowledge graph.

At step 404, the numerical representation of each of the identified assessment papers (the plurality of meta-tagged assessment papers) are compared, using one or more of a similarity based metrics for assigning a numerical score to each such possible pair of the identified assessment papers. In one example embodiment, cosine similarity may be used as a metric. The similarity metric assigns the numerical score to each pair of assessment papers. The assessment papers having the numerical scores greater than a predetermined range of scores are treated to be similar to one another, for this purpose.

At step 406, the identified assessment papers are clustered into the second set of assessment papers based on the numerical scores assigned to each such possible pair of the identified assessment papers. The identified assessment papers are clustered into the second set of similar assessment papers having the numerical scores greater than a predetermined threshold, for generating the second set of similar assessment papers. The identified assessment papers are clustered using the following steps. In one step, a similarity score is computed for quantifying a similarity between any two assessment papers using the numerical score assigned by one or more of the similarity based metrics to each such possible pair of assessment papers. In another step, each similarity score computed between any two assessment papers is used in a graph algorithm to cluster the identified assessment papers for generating the second set of assessment papers.

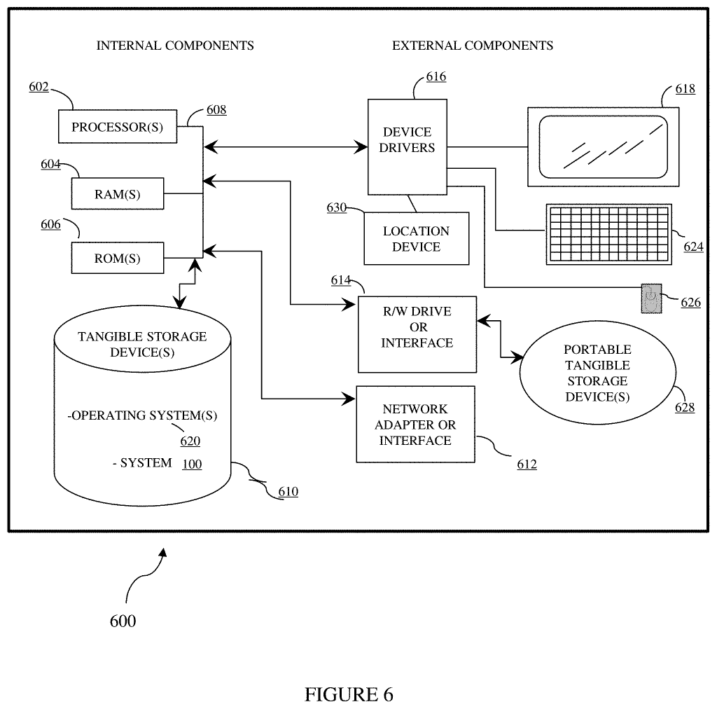

FIG. 6 is a block diagram 600 for of a computing device utilized for implementing the system 100 of FIG. 1 and the system 200 FIG. 2 implemented according to an embodiment of the present disclosure. The modules of the system 100 and 200 described herein are implemented in computing devices. The computing device 600 comprises one or more processor 602, one or more computer readable memories 604 and one or more computer readable ROMs 606 interconnected by one or more buses 608.

Further, the computing device 600 includes a tangible storage device 610 that may be used to execute operating systems 620 and modules existing in the system 100. The various modules of the system 100 can be stored in tangible storage device 610. Both, the operating system and the modules existing in the system 100 are executed by processor 602 via one or more RAMs 604 (which typically include cache memory).

Examples of storage devices 610 include semiconductor storage devices such as ROM 606, EPROM, EEPROM, flash memory, or any other computer readable tangible storage devices 610 that can store a computer programs and digital data. Computing device also includes R/W drive or interface 614 to read from and write to one or more portable computer-readable tangible storage devices 628 such as a CD-ROM, DVD, and memory stick or semiconductor storage device. Further, network adapters or interfaces 612 such as a TCP/IP adapter cards, wireless WI-FI interface cards, or 3G or 4G wireless interface cards or other wired or wireless communication links are also included in the computing device 600. In one embodiment, the modules existing in the system 100 can be downloaded from an external computer via a network (for example, the Internet, a local area network or other, wide area network) and network adapter or interface 612. Computing device 600 further includes device drivers 616 to interface with input and output devices. The input and output devices can include a computer display monitor 618, a keyboard 624, a keypad, a touch screen, a computer mouse 626, or some other suitable input device.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A method for generating a second set of similar assessment papers, from a first set of assessment papers, the method comprising:
identifying a plurality of meta-tagged assessment papers of the first set of assessment papers based on a numerical representation of each assessment paper of the first set of assessment papers, wherein, the numerical representation of each assessment paper is auto-derived based on a plurality of metadata or descriptors, or both, associated with each question of the first set of assessment papers;
comparing the numerical representation of each of the identified assessment papers with the numerical representations of each of the other identified assessment papers, using one or more similarity based metrics, for assigning a numerical score to each such possible pair of the identified assessment papers; and
clustering the identified assessment papers into the second set of assessment papers based on the numerical scores assigned to each such possible pair of the identified assessment papers.

2. The method as claimed in claim 1, wherein clustering the identified assessment papers into the second set of similar assessment papers is based on pairs having numerical scores greater than a predetermined threshold.

3. The method as claimed in claim 1, wherein clustering the identified assessment papers comprises the steps of:
computing a similarity score for quantifying a similarity between any two assessment papers using the numerical score assigned by one or more similarity based metrics to each such possible pair of assessment papers; and
using each similarity score computed between any two assessment papers in a graph algorithm to cluster the identified assessment papers for generating the second set of assessment papers.

4. The method as claimed in claim 1, wherein the first set of assessment papers are generated by implementing one of automatic test generation methods and manual methods.

5. The method as claimed in claim 1, comprising computing the plurality of metadata or descriptors, or both, for each question of the first set of assessment papers, by implementing one or more AI models trained using one of expert labelled data and calibrated labelled data.

6. The method as claimed in claim 1, wherein each question of the first set of assessment papers comprises:
questions obtained from a database wherein each question is associated with a plurality of metadata or descriptors, or both, and is linked to a node of a knowledge base; and
a newly added question wherein the plurality of metadata or descriptors, or both, for the newly added question is computed by implementing one or more AI models.

7. The method as claimed in claim 5, wherein the expert labelled data for each question is derived with the assistance of a plurality of experts in an area of knowledge related to each question and is determined using techniques such as majority voting and bias discounting.

8. The method as claimed in claim 5, wherein the calibrated labelled data is derived using historical user attempt data extracted from the data store.

9. The method as claimed in claim 5, wherein the calibrated labelled data is derived using statistical modeling from historical user attempt data extracted from the data store and leveraging their mapping to a node of the knowledge graph.

10. The method as claimed in claim 1, wherein the plurality of metadata or descriptors, or both, of each question comprise data selected from a list of data comprising, but not limited to, data obtained from contextualized knowledge graph mapping, ideal time, discrimination slope, guessability, behavioral attributes, bloom level tagging, question sequencing, chapter, difficulty level of the question, average time to answer the question, and node of a knowledge graph associated with the question.

11. The method as claimed in claim 10, wherein the behavioral attributes comprise, but are not limited to, data obtained based on careless mistakes, overtime incorrects, too fast corrects, time spent not attempting on a question.

12. The method as claimed in claim 3, comprising:
improving the similarity score of an assessment paper having low similarity scores with more than a predetermined number of assessment papers with which it is compared; and
replacing one or more questions of the assessment paper.

13. The method as claimed in claim 1, comprising identifying a clique of assessment papers using graph representation, wherein the similarity score between two test papers of the pair is used as the relationship.

14. A system for generating a second set of similar assessment papers, from a given first set of assessment papers, the system comprising a processor in communication with a memory, the memory coupled to the processor, wherein the memory comprises a plurality of modules capable of being executed by the processor to perform operations, the plurality of modules comprising:
an identification module for identifying a plurality of meta-tagged assessment papers, of the first set of assessment papers based on a numerical representation of each assessment paper of the first set of assessment papers, wherein the numerical representation of each assessment paper is auto-derived based on a plurality of predicted metadata or predicted descriptors, or both, associated with each question of the first set of assessment papers;
a test paper similarity module for comparing the numerical representation of each of the identified assessment papers with the numerical representations of each of the other identified assessment papers, using one or more similarity based metrics, for assigning a numerical score to each such possible pair of the identified assessment papers; and
a threshold indicator module for clustering the identified assessment paper into the second set of similar assessment papers is based on pairs having numerical scores greater than a predetermined threshold, for generating the second set of similar assessment papers.

15. The system as claimed in claim 14, wherein the threshold indicator module is configured for clustering the identified assessment papers by:
computing a similarity score for quantifying a similarity between any two assessment papers using the numerical score assigned by one or more similarity based metrics to each such possible pair of assessment papers; and
using each similarity score computed between any two assessment papers in a graph algorithm to cluster the identified assessment papers for generating the second set of assessment papers.

16. The system as claimed in claim 14, comprising a prediction module for predicting the plurality of metadata or descriptors, or both, for each question by implementing one or more AI models trained using at least one of expert labelled data or calibrated labelled data.

17. The system as claimed in claim 14, wherein each question of the first set of assessment papers comprises:
questions obtained from a database; wherein each question is associated with the plurality of metadata or descriptors, or both, and is linked to a node of a knowledge base; and
a newly added question; wherein the plurality of metadata or descriptors, or both, for the newly added question is predicted by implementing one or more AI models.

18. The system as claimed in claim 14, wherein the plurality of metadata or descriptors, or both, of each question comprise data selected from a list of data comprising, but not limited to, data obtained from contextualized knowledge graph mapping, ideal time, discrimination slope, guessability, behavioral attributes, bloom level tagging, question sequencing, chapter, difficulty level of the question, average time to answer the question, node of a knowledge graph associated with the question.

19. The system as claimed in claim 14, comprising:
a test paper improvement module for improving the similarity score of an assessment paper having low similarity scores with a more than a predetermined number of papers with which it is compared; and
a question replacement module configured for replacing one or more questions of the assessment paper.

20. The system as claimed in claim 14, comprising a clique detection module configured for identifying clique of assessment papers using graph representation, wherein the similarity score between two test papers of the pair is used as the relationship.
